(19) United States
(12) Patent Application Publication
(10) Pub. No.: US 2017/0238319 A1
(43) Pub. Date: Aug. 17, 2017

(54) SYSTEM, USER EQUIPMENT AND BASE STATION FOR CARRIER SELECTION IN A WIRELESS TELECOMMUNICATION SYSTEM

(71) Applicant: IPCom GmbH & Co. KG, Pullach (DE)

(72) Inventors: Achim LUFT, Braunschweig (DE); Andreas SCHMIDT, Braunschweig (DE); Martin HANS, Bad Salzdetfurth (DE)

(21) Appl. No.: 15/518,650

(22) PCT Filed: Oct. 19, 2015
(86) PCT No.: PCT/EP2015/074156

§ 371 Date: Apr. 12, 2017

(30) Foreign Application Priority Data
Oct. 20, 2014 (EP) 14189529.2

(51) Int. Cl. H04W 72/04; H04W 72/10; H04L 27/00

(52) U.S. Cl. CPC H04W 72/0453; H04L 27/0006; H04W 72/10; H04W 84/12

(57) ABSTRACT

The present invention is directed towards a system for co-existance optimizations of different radio technologies in a wireless telecommunication system. In particular, it relates to technology adapted to operate according to the IEEE 802.11 family of standards, commonly known as Wi-Fi or WLAN, and technology adapted to operate in accordance with mobile communication standards such as the “Long Term Evolution”, or LTE, transmission technology.

The present invention is directed towards a system for carrier selection in a wireless telecommunication system. In particular, it relates to a combination of technology adapted to operate according to the IEEE 802.11 family of standards, commonly known as Wi-Fi or WLAN, and technology adapted to operate in accordance with mobile communication standards such as the “Long Term Evolution”, or LTE, transmission technology. Accordingly a method, user equipment and a base station of selecting a carrier for radio communication according to a communication protocol are disclosed. Another aspect this invention is directed towards is the co-ordination between WLAN and LTE resources in a mobile terminal in order to optimize parallel operation and minimize interference. While both invented optimizations in terms of LTE/WLAN co-operation work fully independently, a combination is also proposed to increase efficiency further.

WO 2012/0172075 A1 describes a wireless communication system which monitors interference levels in different frequencies as a function of time in order to determine a priority of each frequency which is available in a particular area.

US 2014/0016578 A1 describes a system in which a number of different frequency sharing apparatuses each report context information including wireless access scheme, transmission power, spectrum sensing threshold value and position to a respective coexistence manager, the multiple coexistence managers being interfaced for the sharing of information.

WO 2013/179095 A1 shows a cellular access node collecting interference information in a plurality of channels in unlicensed spectrum and the usage of the collected information to update an allocation of the channels among at least two different access points.

EP 2 696 530 A2 provides a method for communication in a wireless telecommunication system. The method comprises adaptively designating, by a network element following a frame-based communication protocol, for use as secondary component carrier in a carrier aggregation scheme, at least a portion of radio resources on an unlicensed band. However, this prior art does not provide a technical teaching that provides the full benefits of Wi-Fi, which would arise from a consideration of specific transmission parameters being indicated by for instance a beacon. Instead only measurements on a power reception relating to beacons and timing values are considered. Furthermore it lacks efficiency as no threshold is provided regarding a necessity to determine further transmission parameters.

US 2014/0092844 A1 provides a carrier selection method for positioning measurement, which is applied to positioning measurement in a carrier aggregation scenario.

Furthermore, baseband processors including their architecture, design, implementation and usage scenarios are known. A device having both Wi-Fi and LTE capability would generally have a module controlling access to the Wi-Fi spectrum, generally referred to as a Wi-Fi baseband processor or just simply a Wi-Fi baseband, and a module controlling access to the LTE spectrum, termed an LTE baseband processor or simply an LTE baseband.

An extension of LTE Advanced to the unlicensed spectrum can provide better coverage and capacity than Wi-Fi deployed by network operators, while allowing for seamless flow of data between licensed and unlicensed spectrum through a single core network. This allows operators to augment their capacity of their networks by utilization of the unlicensed spectrum more efficiently while also providing the tightest possible interworking between the licensed and unlicensed bands. This results in higher data rates, seamless use of both licensed and unlicensed bands, higher reliability, better mobility and further more.

The utilisation of LTE in an unlicensed spectrum, such as 5 GHz, is in the following referred to as LTE in unlicensed bands (LTE-U) but also known as licensed-assisted-access (LAA) Hence, throughout this application LTE may also be referred to as LTE-U. LTE-U and Wi-Fi networks should enjoy equal access to the unlicensed band regarding time and spectrum bandwidth, which results in a reduction of bandwidth in case many networks are operating in the same band. When demand exceeds the network capacity, each network must be able to access an equal share. While the invention is described with reference to unlicensed radio frequency bands, the invention is not so limited and may be employed in the licensed spectrum subject to such approval for use as may be required by the licensing authorities.

In the current standardisation discussions, an operation of LTE in the unlicensed band in parallel to the current usage of the licensed bands is planned. The LTE usage in these unlicensed bands must be accomplished in parallel to the operated services, such as WLAN, and the resource management should be fair regarding the consideration of further network operators and private users.

The requirements for the coexistence of LTE in the unlicensed spectrum have been discussed, for example, at a workshop held on Jun. 19, 2014 in Sophia Antipolis, organized by 3GPP, with the papers presented being available at http://.3gpp.org/ftp/workshop/2014, Jun. 13_LTE-U/. While studies have shown that access based on LTE technology would be more efficient than Wi-Fi/WLAN, care needs to be taken to allow both technologies fair access to the available spectrum. Typically, such co-existence proposals rely on channel sensing considerations, broadly termed “listen before talk”.

There is a need for a WLAN specific carrier selection as well as a coordination of transmission resources for parallel usage. A WLAN specific carrier selection allows for a more effective carrier selection than an energy measurement of the respective channel and the required extensions to the LTE based band can be minimized. The required carrier selections can be outsourced in different parts of a user equipment and can therefore be parallelized. The 5 GHz-RF-module including analogue filters and an antenna can either be shared as a common resource or for the case of a parallel implementation (LTE-U and WLAN) can be synchronized and interferences can be minimized.

While the state of the art merely discusses a coexistence on a conceptional level the prior art fails to describe concrete implementations of a combination of LTE and WLAN/Wi-Fi technology. As far as hardware concerns are addressed the state of the art sticks to the separate implementation of hardware devices merely aggregating WLAN and LTE technology. Hence, the prior art teaches to provide full LTE hardware and furthermore to provide full WLAN hardware. What is needed is an integrated approach towards a common usage of hardware and software components for a combined usage towards LTE and WLAN.

Hence, it is an object of the present invention to provide a system, a user equipment and a base station along with respective methods for operation thereof, which provide an integrated approach of a true combination of LTE and WLAN. It is furthermore an object of the present invention to provide at least one computer readable medium comprising instructions stored thereon implementing the suggested methods.

This object solved by a system and method for LTE carrier selection in a wireless telecommunication system holding features according to claim 1.

Accordingly, a method of selecting a carrier for radio communication according to a first communication protocol is provided, the method comprising determining for each of a plurality of possible carriers a measurement of transmission energy; for each carrier having a measured transmission energy greater than a predetermined threshold, attempting to determine a further transmission parameter according to a second communication protocol; assigning to each of the plurality of possible carriers, a priority value using the measurement of transmission energy and determination of the further transmission parameter; and selecting a carrier for communication according to the first communication protocol dependent on the assigned priority values.

According to a further aspect of the present invention the further transmission parameter is an identification parameter. The identification parameter can for instance be formed by an ID of a router, such as a SSID. In this way specific hardware devices can be assigned further control logic having an impact on the priority value. In case a specific router is identified the respective carrier on which this router sends can be of low priority. Hence, a priori known routers, or hardware devices in general, can also block carriers they are sending on. In a usage scenario where routers of a specific manufacturer are identified through the identification parameter their respective carriers will not be further used for transmission of user equipment due to legal regulations or contractual restrictions. This provides the advantage that certain hardware specifications can be considered when assigning a priority value.

According to a further aspect of the present invention the first communication protocol is in accordance with the Long Term Evolution, LTE, standards. Especially the standards LTE-A and LTE-U are addressed. The person skilled in the art finds respective documentation for instance in the 3GPP specification.

According to a further aspect of the present invention the second communication protocol is in accordance with the IEEE 802.11 family of standards. Especially the standards IEEE 802.11, IEEE 802.11a, IEEE 802.11b, IEEE 802.11g, IEEE 802.11n, IEEE 802.11 and further more are addressed. This set of standards may also be referred to as Wi-Fi or WLAN. The present invention provides the advantage that an integrated approach of the LTE and IEEE 802.11 standards is achieved. Hence, the suggested measurements can be performed by a WLAN module and the transmission of data is performed by an LTE module for instance in the unlicensed frequency band.

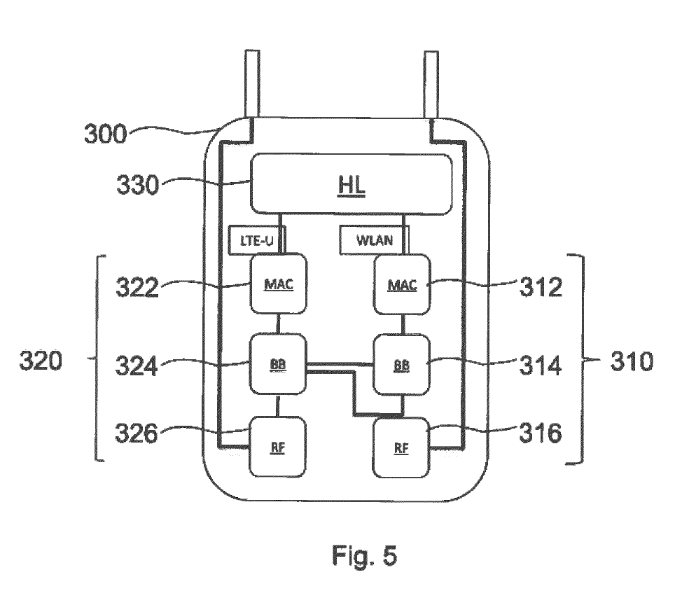

According to a further aspect of the present invention a carrier in which an ad-hoc mode transmission is detected is given a higher priority than a carrier in which an infrastructure mode transmission is detected. This aspect is discussed in detail in the context of FIG. 5.

According to a further aspect of the present invention a carrier in which energy from an unknown source is detected is given a higher priority than a carrier in which either an ad-hoc mode or an infrastructure mode transmission is detected.

According to a further aspect of the present invention transmissions according to the first communication protocol are coordinated with transmissions according to the second communication protocol. Hence, not only a coexistence of standards is suggested but rather an integrated approach, for instance for combining benefits of WLAN and LTE.

According to a further aspect of the present invention transmissions according to the first communication protocol and the second communication protocol are accomplished over the same antenna device. This provides the advantage that hardware resources can be efficiently used. This enables that the LTE functionality accesses the RF-module of the WLAN functionality. In case a user equipment is implemented such that LTE modules and WLAN modules are present at least one LTE module, especially the LTE baseband, can be coupled to the WLAN antenna. Hence, one single antenna serves for both the LTE as well as the WLAN functionality.

According to a further aspect of the present invention operation of the first communication protocol and operation of the second communication protocol is coordinated over a shared interface. Such an interface may couple each of the basebands, for instance the LTE and the WLAN basebands, for joint operation. It is furthermore of advantage that the interface can be used for coupling the LTE baseband with the RF-antenna.

According to a further aspect of the present invention a location detection is performed, which is considered when assigning to each of the plurality of possible carriers a priority value. A user equipment holding location detection functionality, for instance using GPS or cell based location techniques, can use geographic location stamps for computing priority values considering legal regulations or contractual restrictions. It may be the case that in some regions single carriers are blocked or reserved for specific purposes.

According to a further aspect of the present invention a hardware configuration is considered when assigning to each of the plurality of possible carriers a priority value. In this way load balancing can be performed and the involved hardware can be adapted the characteristics of specific carriers.

According to a further aspect of the present invention measurements on respectively neighbouring carriers are considered when assigning to each of the plurality of possible carriers a priority value. Hence, interference levels and transmission behaviour can be considered for the assignment of priority values. It is also of advantage to detect transmission parameters, for instance being broadcast through beacons, and evaluate them for an adapted assignment of priority values.

Furthermore a method of selecting a carrier for transmissions in an unlicensed frequency band in accordance with the Long Term Evolution standards, is suggested the method comprising using a baseband module adapted to operate according to the IEEE 802.11 family of standards to measure a received signal energy for a multitude of carriers, e.g. for each possible carrier; using the baseband module to determine a further parameter at least for the multitude of carriers having a received signal energy greater than a predetermined threshold; allocating a priority value to each of these carriers as a result of the received signal energy measurements and the further parameter determinations; and selecting a carrier dependent on the priority values of the possible carriers.

Furthermore a radio communication terminal having a transmission capability for transmitting in accordance with a first radio communication protocol and a transmission capability for transmitting in accordance with a second radio communication protocol is suggested, the terminal including a first processor module and a second processor module, the first processor module being configured to manage radio functions for transmission according to the first radio communication protocol and the second processor module being configured to manage radio functions according to the second communication protocol, characterized in that an interface is provided between the first processor module and the second processor module and wherein the first processor module is adapted to communicate with the second processor module in a manner such that a search for a suitable carrier for transmissions according to the first communication protocol is performed by the second processor module.

A radio communication terminal may also be referred to as user equipment, cell phone or a mobile device in general. The notion of protocol describes any algorithm or set of rules, which may be stored and executed across devices of a network. It is therefore possible to distribute method steps and/or hardware devices over said network and provide communication interfaces for a joint application of the protocols.

Furthermore a base station having a transmission capability for transmitting in accordance with a first radio communication protocol and a transmission capability for transmitting in accordance with a second radio communication protocol is suggested, the base station including a first processor module and a second processor module, the first processor module being configured to manage radio functions for transmission according to the first radio communication protocol and the second processor module being configured to manage radio functions according to the second communication protocol, characterized in that an interface is provided between the first processor module and the second processor module and wherein the first processor module is adapted to communicate with the second processor module in a manner such that a search for a suitable carrier for transmissions according to the first communication protocol is performed by the second processor module.

The base station comprises devices such as a router, a mobile device and any intermediate device spanning up a communication cell.

Also, a system for LTE carrier selection in a wireless telecommunication system is provided, the system comprising a WLAN module being arranged to measure at least one carrier performance parameter per at least one carrier as well as a carrier priority module being arranged to assign a priority value to each of the at least one carrier as a function of the measured at least one carrier performance parameter and furthermore an LTE module being arranged to transmit on a carrier being selected by a carrier selection module as a function of the assigned priority value.

The suggested system for LTE carrier selection may be implemented by a single device or the respective modules may also be implemented in a separated fashion on several devices, such as a user equipment and a base station. Therefore, it is possible to implement the WLAN in a user equipment and furthermore deploy the LTE module on a base station. It may also be useful to connectively couple a server module with a user equipment and/or the base station, which provides a carrier priority module and/or a carrier selection module upon request. It may also be of advantage to implement the suggested system the other way round by deploying the WLAN module on a base station and to implement the LTE module in a user equipment.

A user equipment may be any device such as a mobile phone, a laptop, a handheld computer, a navigation system, a tablet computer, a desktop computer, a location static device or a mobile device. The base station may be implemented as any mobile or stationary device, such as a router or any sending device. It may furthermore be the case that a mobile phone acts as a base station operating an ad-hoc network. Hence, the present invention can also be accomplished in a mobile scenario with some of the modules being implemented on a first user equipment and some of the other modules being implemented on a second user equipment.

The LTE carrier selection refers to a channel selection, which may involve further telecommunication techniques, such as carrier sensing, which is an integral part of Wi-Fi networks. Wi-Fi is a multiple access link, which means that it provides shared resources and requires vastly different protocol design and architecture than a point-to-point circuit. Random access to the medium is distributed across all stations on the network. Carrier sensing may in general be referred to as measuring the interference on specific channels. Carrier selection may further involve energy detection, which refers to the ability of the receiver to detect the Wifi or non Wi-Fi energy level present on the current channel, based on the noise floor, ambient energy, interference sources and unidentifiable Wi-Fi transmissions that may have been corrupted and can no longer be decoded. Unlike carrier sensing, which can determine the exact length of time the medium will be busy with the current frame, energy detection must sample the medium every slot time to determine if the energy still exists. For selecting a specific carrier, also referred to as channel or frequency band, metrics must be applied for determination which carrier or channel should be used for further transmission. The term carriers in the sense of this invention and the selection of one specific carrier out of a multitude of carriers includes selecting a single frequency band out of a multitude of frequency bands that are adjacent to each other in the frequency domain. The selection may also include selecting multiple such carriers out of the multitude of adjacent frequency bands. Further, carriers may include frequency bands that are not adjacent in the frequency domain and the selection may include selecting one or more of these not adjacent frequency bands. Further, the single carrier or multiple of carriers that are chosen from the multitude of carriers may themselves consist of a multitude of adjacent frequency bands that may be used collectively or that may be subject of a further carrier selection in subsequent steps of the carrier selection method.

The present invention provides a means for cooperation of a mobile telecommunications baseband and a WLAN module, which means either a direct cooperation with an extended WLAN baseband or a common WLAN module over its configuration interface and furthermore superior functions regarding the communication between baseband modules, such as the mobile communication (e.g. LTE) baseband and the WLAN baseband, is provided. This cooperation comprises the topics of carrier selection, as described above, and coordination/synchronisation issues while transmitting data.

Carrier selection may be accomplished before performing an LTE-U data transmission. A carrier selection may be based on the evaluation of WLAN beacons and is of advantage, compared to an approach being merely directed towards an energy measurement. As the required functionality for evaluation of WLAN beacons is already present in the WLAN baseband, which is separated from LTE baseband and the LTE frequency bands use the same frequency range, as well as the same channel width, up to 20 MHz, exactly as the present WLAN, the WLAN baseband can accomplish such a carrier selection as requested or invoked by the LTE-U baseband. For doing so three possibilities are suggested:

Firstly, the mobile telecommunication base station indicates if and how a carrier selection should be accomplished by the mobile terminal. This indication may also include the desired configuration of the LTE-U operation. Several alternative configurations may be transmitted from the mobile telecommunications base station to the mobile terminal.

Secondly, an interface is implemented between the LTE baseband and the WLAN baseband, which allows the LTE baseband to request a carrier selection from the WLAN baseband with specific parameters for the respective measurement. Furthermore, said interface may provide the possibility to the WLAN baseband to return the results of the measurement and to return the used resources for said measurement back to the LTE baseband.

Thirdly, the mobile terminal can indicate to the mobile telecommunication base station, which activities are detected on its specific location, for instance by usage of a location stamp, in the respective unlicensed bands. Furthermore, the mobile terminal can report to the base station which carriers for an LTE-U activity, such as an LTE transmission, are selected and it can act in these bands being found to be available. Therefore, the mobile terminal may use the configuration as provided by the base station with or without reporting the resulting selected carrier back to the base station.

The aspect of the carrier selection being accomplished by the WLAN module as requested by the mobile communication baseband differs from the known measurement of the WLAN carrier and a posteriori reporting by the direct usage of the measurement results for the LTE-U transmission, which implies a different range of measurements and evaluation techniques.

However, it is possible before the carrier measurements itself to consider the status of the WLAN module. It may for instance be the case that a carrier, which is used by the WLAN module for data transmission according to the WLAN standard, such as IEEE 802.11 a/b/g/n/ . . . , is excluded for the usage of LTE-U. Alternatively a present usage of the WLAN module in the mobile terminal for data transmission could exclude a usage of LTE-U. This may be the case if a simultaneous usage of LTE-U and WLAN is in general not possible, maybe according to hardware restrictions.

Furthermore, a selection of a potential frequency for LTE-U usage may be restricted by the device internal RF module. This may be the case if a parallel transmission in LTE-U and WLAN is only possible in case both modules transmit on directly neighbouring carriers. This occurs if from a RF point of view a transmission on a 40 MHz carrier is accomplished instead of two separate 20 MHz carriers. In contrast to this a parallel transmission may be only possible if both frequencies have a certain distance to each other, which means that the WLAN-Tx-signals only have a limited interfering impact on the LTE-U-signals, such as Tx or Rx, and vice versa.

Therefore, it is suggested, that the WLAN module alone or in cooperation with the mobile telecommunication baseband, which means the LTE-U module, selects one or several carriers being optimal for the mobile terminal or for the whole system in its current usage under consideration of its hardware design. On this selected carrier WLAN specific measurements are accomplished, which are reported to the LTE-U module, for instance along with indications of currently unavailable carriers. This information is further processed by the LTE-U module.

A further aspect provided by the present invention is the cooperation/synchronisation while transmitting data. Transmission specifications of a system, for instance WLAN, can lead to transmission and reception pauses, which can be used by the respectively other system, such as LTE-U, for the transmission of data or for accomplishing short measurements. Likewise a system can arrange its operations in a fashion that for a predictable period of time sending/or reception of data from the respectively other system is possible or restricted. Such operation configurations can be coordinated to operate both systems in parallel. The coordination comprises the reporting of WLAN activity times by the WLAN module to the LTE module and that the LTE-U module does not use LTE in case these activities would interfere with the respectively other activities. It may be the case that the LTE module transmits data alternatively over the LTE infrastructure or delays its transmission or reception. The other way round it may be possible that the LTE module reports LTE-U activities to the WLAN module, which does not accomplish any activities during the reported periods of time.

A superior routing function may adapt the routing of data over WLAN, LTE-U or LTE as a function of the activity information of the separate modules. It may be of advantage that a current usage of the WLAN module in the mobile terminal under consideration of the filling level of the WLAN sending buffer and/or according to the category of the current service provided over WLAN can lead to a delayed LTE-U usage.

The WLAN module may be a unit that operates on the basis of a contention-based protocol such as Wi-Fi protocol, for instance according to the IEEE 802.11 standard. Therefore the WLAN module may as well be a Wi-Fi module. The WLAN module may comprise a further component such as an antenna and/or RF device. The WLAN module is arranged to measure at least one carrier performance parameter, also referred to as channel performance parameter. A carrier may be a physical channel on which a WLAN, LTE or any telecommunication device transmits signals. The measured carrier performance parameters are taken for each of the available channels or carriers and may comprise an interference level and/or an energy level measured on the respective channel. Hence, several measurements are performed while the set of measured carrier performance parameters may also differ per channel. It may be the case that on a first channel five carrier performance parameters are measured and on a second channel three carrier performance parameters are measured. For ease of use it may be of advantage to measure always the same set of carrier performance parameters for each of the channels.

Furthermore a carrier priority module is arranged to assign a priority value to each of the at least one carrier. The carrier priority module provides the functionality and further logic to evaluate the measured carrier performance parameters and interpret them according to a priority metric. It may be the case that for instance a neighboring base station is measured or a WLAN router being close to the mobile device is detected. As several routers may be detected in close proximity to the mobile device it may be of advantage to interpret the information provided by each of the neighboring routers. A router is typically arranged to broadcast signaling information through so-called beacons. Such beacons describe the transmission behavior of a sending device, such as a router. Hence, the possibility is provided to exclude some a priori known routers from transmission. This may be accomplished by assigning a low priority value to carriers being used by specific routers. In case a positive carrier performance parameter is detected, such as a low interference level, a high priority value is assigned. Hence, the priority value can be used as a measure for the quality of each of the currently available carriers.

The carrier priority module is arranged to access a data storage or a further data source which provides a priority metric. The priority metric comprises rules which allow an interpretation of the measured carrier performance parameters. An example of such a rule is that carriers with a low interference level are always assigned a high priority value. The priority value may also be computed under evaluation of several carrier performance parameters. The measured carrier performance parameters may also detect that specific services are provided by service providers, which pose special requirements regarding the usage of a channel or carrier. Hence, the carrier performance parameter may indicate that services, which are measured by the WLAN module are restricted by legal regulations or by specific terms of use. In case such restrictions are detected the priority metric may assign a low priority value to a specific carrier.

The carrier priority module can be located in a user equipment, a base station, a router or in any external device. It may be of advantage to provide a server which performs the application of the priority metric and therefore operates the carrier priority module. Such functionality can be provided by hardware or by specialized software components. The carrier priority module may be deployed on the same server as the respective priority metric.

The LTE module, also referred to as LTE-U module, is arranged to transmit on the carrier being selected by a carrier selection module. The carrier selection module evaluates the priority values and chooses the best carrier to transmit on. For ease of use the carrier priority module and the carrier selection module may be provided by a single unit, which provides the overall functionality of evaluation of the carrier performance parameters and directly after evaluation of said carrier performance parameters performing the selection of the most appropriate carrier. However, the carrier selection module provides the possibility to consider an additional metric, which interprets the assigned priority values. While the carrier priority module and the carrier selection module may be implemented as a single module it may be of advantage to have separate carrier priority modules and separate carrier selection modules, which can then be deployed on different devices. Therefore it is possible to deploy the carrier priority module on a user equipment and to further deploy the carrier selection module on a base station. Hence, the user equipment provides the priority values and the base station selects an appropriate carrier to transmit on. The same as being described for the priority metric holds for the carrier selection metric. It may be provided by an additional device and may furthermore include rules for carrier selection. Finally, after a carrier is selected the LTE module transmits on the selected carrier.

Hence, close cooperation between the WLAN module and the LTE module is implemented as the WLAN module measures parameters on carriers, which can be directly used for transmission by the LTE module. This results in resource efficiency as functionality has not to be provided by the WLAN module and redundantly by the LTE module. According to the features as described above a new interface is provided, which directly couples the WLAN module to the LTE module, which allows for transmission and reception of LTE-U data over the WLAN-RF-module. According to this technical teaching a carrier sensing of the WLAN baseband for the LTE protocol stack is made possible.

According to the present invention a single unit is provided comprising at least one of the WLAN module, the carrier priority module, the LTE module and the carrier selection module. It is therefore possible to provide a single unit comprising any of the aforementioned modules, which includes a subset of the aforementioned modules. Hence, a further unit can be provided which holds the rest of the required modules. A deployment of these for instance two units across several hardware devices is enabled.

According to a further aspect of the present invention the at least one carrier performance parameter indicates an interference level on a carrier. This provides the advantage that among other carrier performance parameters commonly known parameters being measured by legacy systems can also be considered by the present invention.

According to a further aspect of the present invention the carrier priority module is arranged to assign the priority value as a function of at least one value indicating a geographic position of a user equipment/or WLAN signaling, such as a beacon. This provides the advantage that the carrier priority module may for instance be deployed on a user equipment, which is arranged to measure its current location by means of GPS or cell based location detection. Hence, location based services can be considered regarding the carrier selection. Furthermore, a router specification, for instance within a WLAN cell, can be considered.

According to a further aspect of the present invention the carrier with the least interference level is selected for transmission. This provides the advantage that legacy systems relying on energy measurement can be considered when selecting the carrier for the LTE module.

According to a further aspect of the present invention the measurement of the at least one carrier performance parameter is invoked by the LTE module. This provides the advantage that the LTE module is directly coupled to the WLAN module and does not need to address its own hardware and/or software components for the measurement for the at least one carrier performance parameter.

According to a further aspect of the present invention the LTE module operates according to the LTE-U standard. This provides the advantage that several techniques such as WLAN and LTE-U can be integrated into a single system, which goes beyond a simple coexistence of both technologies.

According to a further aspect of the present invention at least one module is arranged to operate at least in part in an unlicensed spectrum, such as 5 GHz. Therefore it is possible to use a huge spectrum, which enables the transmission with additional or enhanced bandwidth. Therefore, technologies referring to licensed spectrum and unlicensed spectrums can be consolidated.

According to a further aspect of the present invention at least one module is comprised in a user equipment and/or base station. This provides the advantage that a telecommunication scenario can be implemented with deployment of modules across several devices such as user equipment or base stations.

According to a further aspect of the present invention the base station is arranged to invoke the measurement performed by the WLAN module. This provides the advantage that the base station may request the measurements from a user equipment providing the WLAN module and can therefore consider the specific conditions of the user equipment although the base station may be in a static location.

According to a further aspect of the present invention the WLAN functionality is provided by at least one hardware adaption of a commonly known WLAN and/or by deployment of instructions through a configuration interface on a commonly known WLAN module. This provides the advantage that existing hardware can be reused and adapted such that an additional interface is integrated into existing devices for instance in a fashion that the LTE-U baseband is connectively couple with the WLAN baseband and/or that the LTE-U baseband is connectively coupled with the RF device of the WLAN. It is furthermore possible to configure the respective devices by usage of a configuration interface, such that the described interface is implemented.

According to a further aspect of the present invention the LTE module provides an interface for communication with the WLAN module for interchanging at least one of the carrier performance parameter, the priority value, the interference level, the location stamp, the WLAN signaling and signals received by an antenna being connectively coupled to the WLAN module. This provides the advantage of a close coupling of the LTE module with the WLAN module. This results in hardware efficiency as for instance parts of the WLAN technology, such as the RF device of the WLAN for the LTE-U device.

The object is also solved by a method for selecting an LTE carrier in a wireless telecommunication system, the method comprising the measuring of at least one carrier performance parameter per at least one carrier by means of a WLAN module as well as assigning a priority value to each of the at least one carrier as a function of the measured at least one carrier performance parameter by means of a carrier priority module and transmitting by means of an LTE module on a carrier being selected by a carrier selection module as a function of the assigned priority value. It is of advantage that this method may be used for operation of the above described system for LTE carrier section.

The object is also solved by respective user equipment and base stations, which perform according to the features of further independent claims. The provided user equipment is arranged in a fashion that it provides at least one of the WLAN module, the carrier priority module, the carrier selection module and the LTE module. This applies also for the suggested base station. In detail a user equipment in a wireless telecommunications system is suggested, the user equipment comprising a WLAN module being arranged to measure at least one carrier performance parameter per at least one carrier, the WLAN module being connectively coupled to a carrier priority module being arranged to assign a priority value to each of the least one carrier as a function of the measured at least one carrier performance parameter, wherein an LTE module transmits on a carrier being selected by a carrier selection module as a function of the assigned priority value.

Furthermore a base station in a wireless telecommunications system is suggested, the base station comprising an LTE module being connectively coupled with a WLAN module being arranged to measure at least one carrier performance parameter per at least one carrier, the WLAN module being connectively coupled to a carrier priority module being arranged to assign a priority value to each of the least one carrier as a function of the measured at least one carrier performance parameter, wherein the LTE module transmits on a carrier being selected by a carrier selection module as a function of the assigned priority value.

The object is also solved by respective methods for operation of the user equipment and the base station according to further independent claims.

The invention will now be described merely by way of illustration with reference to the accompanying drawings in which:

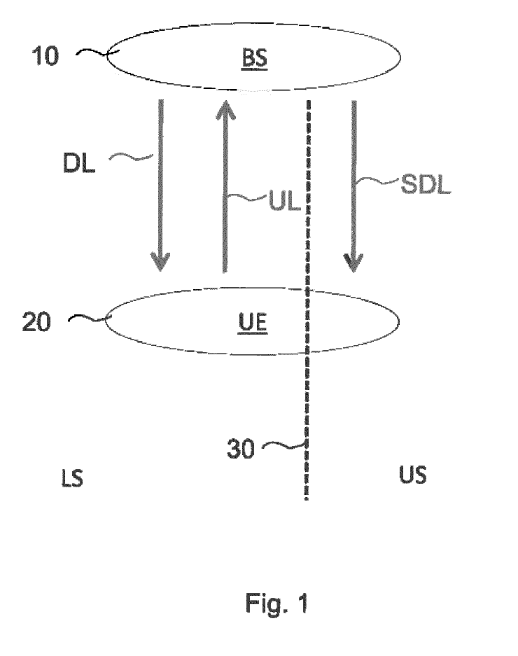

FIG. 1 shows a usage scenario of an aspect of the present invention;

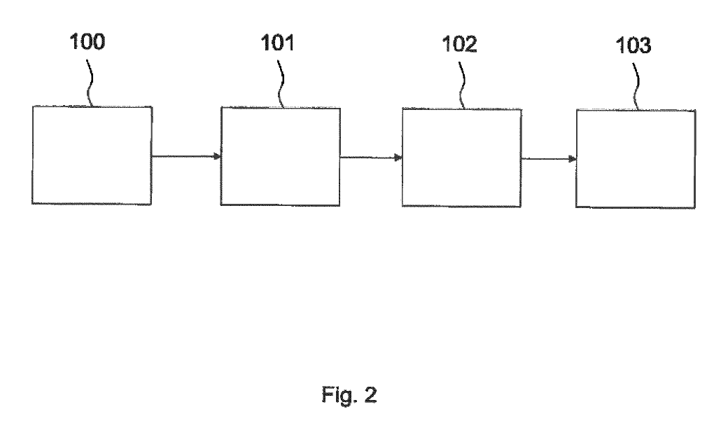

FIG. 2 shows a system for LTE carrier selection according to an aspect of the present invention;

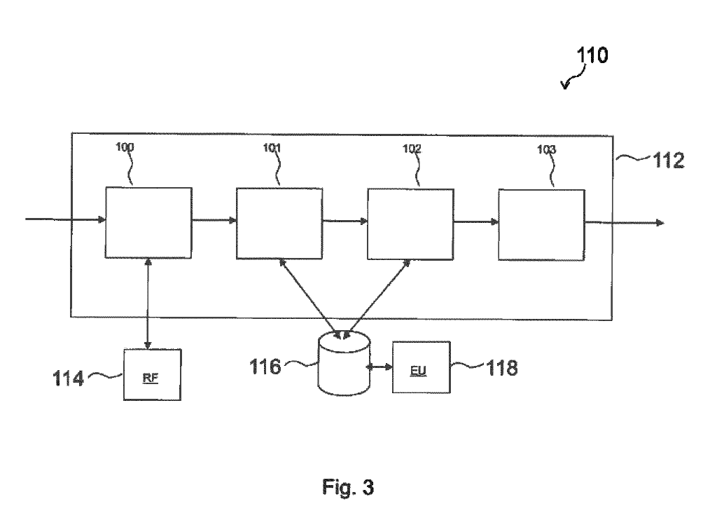

FIG. 3 shows a detailed schematic illustration of a system for LTE carrier selection according to an aspect of the present invention;

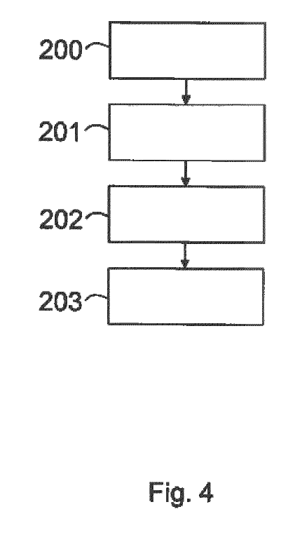

FIG. 4 shows a method for selecting an LTE carrier according to an aspect of the present invention;

FIG. 5 shows a user equipment for LTE carrier selection according to an aspect of the present invention;

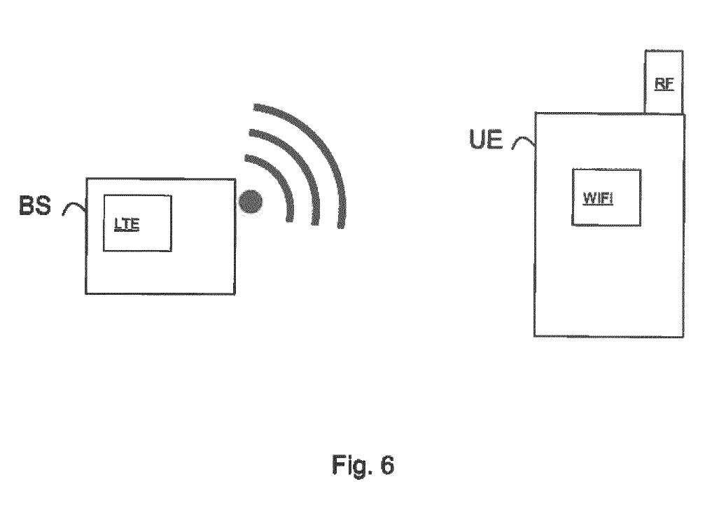

FIG. 6 shows a further system for LTE carrier selection according to a further aspect of the present invention;

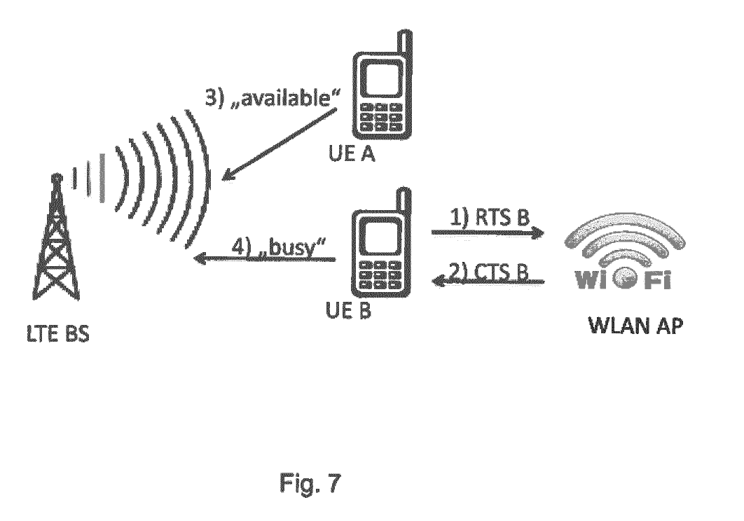

FIG. 7 shows a detailed schematic illustration of a communication protocol for a timing alignment between LTE-U and WLAN according to an aspect of the present invention;

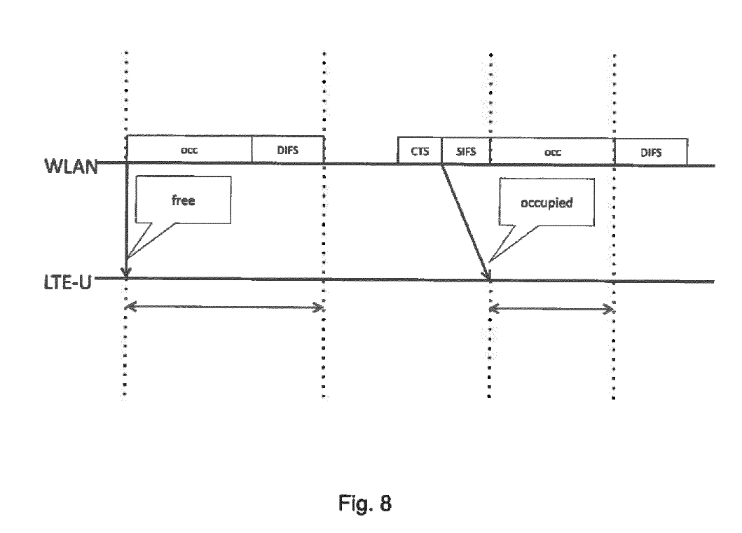

FIG. 8 shows a detailed schematic illustration of a communication protocol for a timing alignment between LTE-U and WLAN according to an aspect of the present invention;

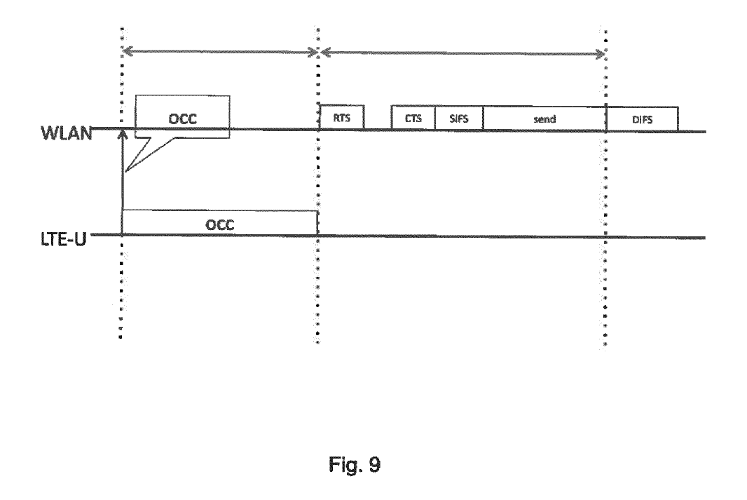

FIG. 9 shows a detailed schematic illustration of a communication protocol for a timing alignment between LTE-U and WLAN according to an aspect of the present invention; and

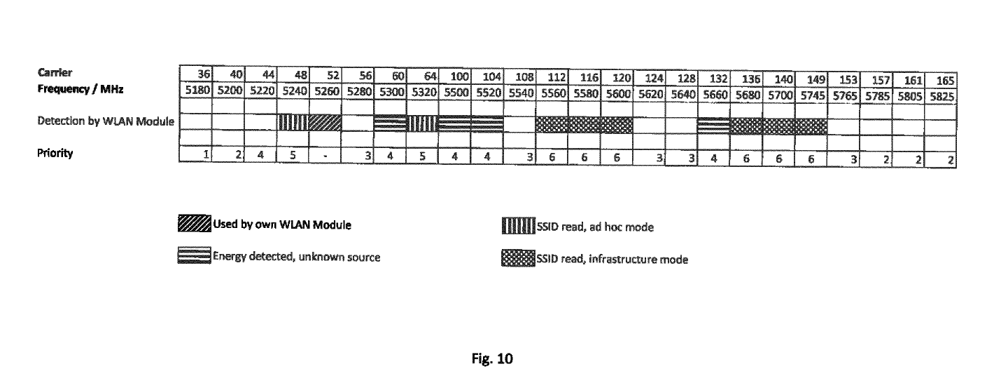

FIG. 10 shows an assignment of priorities to measured carrier performance parameters according to an aspect of the present invention.

FIG. 1 shows in a conceptual manner a base station 10, BS, which communicates with a user equipment 20, UE, in a downlink and an uplink direction, each being depicted by respective arrows. The communication between the base station BS and the user equipment UE is accomplished over licensed spectrum, LS, as indicated in the left portion of FIG. 1 as well as in a downlink direction from the view of the user equipment UE over unlicensed spectrum, US, as indicated in the right portion of FIG. 1. The differentiation between the licensed spectrum LS and the unlicensed spectrum US is indicated by a dotted line 30. Commonly known telecommunication networks send and receive data and signals on licensed frequency bands, which can also be enhanced by the freely available frequency bands, also referred to as unlicensed spectrum, in particular in the frequency of approximately 5 GHz. In the downlink a special uni-directional channel for the enhancement of data rates, the so-called supplementary downlink, SDL, is indicated on the right hand side of the figure.

For minimal interference with other equipment, a form of carrier selection is necessary. Therefore before occupying a specific frequency band, the activities on potentially usable bands are detected and a channel is selected, which is either not in use or the level of use is low. In general WLAN comprises two different approaches for carrier detection as follows. Firstly, there is carrier selection which is the detection of energy per channel broadcast by local transmitters together with the evaluation of WLAN beacons and their SSID (Service Set Identifier), the so-called access point name, together with their modes of operation such as “infrastructure” or “ad-hoc”.

Secondly, there is a so-called RTS/CTS (Request-To-Send/Clear-To-Send) procedure at the MAC (Medium Access Control) level. In this approach time intervals are considered in which the sender has to wait after a channel is recognized as being free or available.

At the time being, in LTE devices there is no such functionality in the terminals as the resource management typically takes places in the network and is communicated to the terminal. Current approaches of LTE-U only address an infrastructure mode in which the LTE base station itself is an LTE-U base station or is in direct communication with such an LTE-U base station and controls it.

Using the LTE standard in unlicensed bands, carrier selection functionality for the usage of LTE would be required. Hence, substantial amendments and enhancements in the LTE baseband and protocol stack would be required, resulting in a redundant implementation or in the provision of a similar functionality in the mobile device.

An uncoordinated or unsynchronized usage of the 5 GHz band leads to severe mutual interference of both access approaches, namely LTE-U and WLAN. A shared usage of a common 5 GHz sending/receiving unit, also referred to as RF, for LTE-U and WLAN is not possible according to the state of the art. Therefore, it is an advantage of the present invention that a WLAN specific carrier selection including the reception and interpretation of the SSID and of the mode, allows for an effective channel selection, which is superior to a pure energy measurement on the respective channels. Hence, legacy functionality can be applied. The required enhancements of the LTE baseband can be minimized and the required carrier selection is sourced out into different areas of the terminal and can therefore be operated in parallel. The 5 GHz-RF module, including analog filters and an antenna, can be shared as a common resource or in the case of a parallel implementation, such as LTE-U and WLAN in separate implementations, can be synchronized. Hence, requirements can be fulfilled for a minimization of interference.

Applying the present invention legacy concepts such as frequency division duplex, FDD, as well as time division duplex, TDD, can be used for the transmission in uplink direction UL as well as in the downlink direction DL, for instance using the licensed spectrum LS.

FIG. 2 shows a system for LTE carrier selection in a wireless telecommunication system, the system comprising a WLAN module 100 being arranged to measure at least one carrier performance parameter per at least one carrier. A carrier priority module 101 is arranged to assign a priority value to each of the at least one carrier as a function of the measured at least one carrier performance parameter and an LTE module 103 is arranged to transmit on a carrier being selected by a carrier selection module 102 as a function of the assigned priority value. Each of the described modules 100, 101, 102 and 103 can be deployed on the same device or each on a different device. It may furthermore be the case that the LTE module 103 invokes the measurement of the at least one carrier performance parameter by the WLAN module 100. Therefore, the depicted arrows indicate only one of several possibilities of data flow. Each of the modules 100, 101, 102 and 103 may be connectively coupled among each other and may also have additional interfaces for communication with further devices, such as data storages, servers and/or network devices.

According to the present embodiment the WLAN module 100 measures the carrier performance parameters and hands them over to the carrier priority module 101, which further evaluates the received carrier performance parameters and assigns a priority value to each of the detected carrier performance parameters or assigns a priority value to a set of received carrier performance parameters. The priority values alone or with further information, such as the carrier performance parameters, are afterwards handed over to the carrier selection module 102, which chooses the best possible carrier for transmitting data thereon. The decision is communicated to the LTE module 103, which starts transmission on the selected carrier, for instance by usage of further devices.

FIG. 3 shows an illustration of a system 110 for carrier selection. According to the present embodiment the aforementioned modules 100, 101, 102 and 103 are comprised on a single device 112. The WLAN module 100 is connectively coupled to an antenna 114, which measures carrier performance parameters such as an energy level. The carrier priority module 101 as well as the carrier selection module 102 are coupled with a data storage 116, which may for instance provide a metric or algorithm for assigning carrier performance parameters a specific priority and/or for selecting an appropriate carrier for further transmission. It may be the case that the priority metric as well as the selection metric are provided by the same data storage or are provided by different data storages. The data storage is coupled to a further evaluation unit 118. This evaluation unit may pose additional restrictions or provide additional logic of a priority assignment or carrier selection. The evaluation unit 118 can be used for updating and/or enhancing rules, which describe the stored metrics. As the bi-directional arrow indicates a data base management system may also request further data from the evaluation unit 118.

The data storage 116 communicating with the carrier priority module 101 and the carrier selection module 102 may be further used for storing lists, which indicate the assigned priority values or the assignment of already selected carriers. Hence, it is possible to store previously made carrier selections or configuration profiles, which can be used by any of the described modules 100, 101, 102 and 103.

The person skilled in the art appreciates that further communication buses are available connecting each of the described modules and data bases. It is furthermore of advantage that additional units can be addressed by the system as well as several of the shown entities can be implemented as single units. It may be desirable, for example, to integrate both the carrier priority module 101 and the carrier selection module 102 on a single unit and therefore perform the carrier selection directly on the measured carrier performance parameters.

FIG. 4 shows a method for selecting an LTE carrier in a wireless telecommunication system, the method comprising measuring 200 at least one carrier performance parameter per at least one carrier by means of a WLAN module 100 and assigning 201 a priority value to each of the at least one carrier as a function of the measured at least one carrier performance parameter by means of a carrier priority module 101 and transmitting 203 by means of an LTE module 103 on a carrier being selected 202 by a carrier selection module 102 as a function of the assigned priority value.

It will be appreciated that further steps may be required for performing the method as the present figures serve only as an overall illustration of an aspect of the present invention.

In an alternative interpretation of FIG. 4 a method of selecting a carrier for radio communication according to a first communication protocol is depicted providing a further embodiment of the present invention. The method step of determining for each of a plurality of possible carriers a measurement of transmission energy is shown under reference sign 200. For each carrier having a measured transmission energy greater than a predetermined threshold an attempt 201 to determine a further transmission parameter according to a second communication protocol is performed. Furthermore assigning 202 to each of the plurality of possible carriers, a priority value using the measurement of transmission energy and determination of the further transmission parameter is accomplished. And finally selecting 203 a carrier for communication according to the first communication protocol dependent on the assigned priority values is suggested.

FIG. 5 shows a user equipment, UE, 300, with LTE-U functionality indicated illustratively on the left hand side and WLAN functionality indicated illustratively on the right hand side. Shown are protocol stacks 310 and 320 each leading to higher layers, HL, 330 which are not shown in detail. Each of the stacks 310 and 320, namely the LTE-U stack and the WLAN stack, comprise a MAC level 312 and 322, a baseband level, BB, 314 and 324 as well as a radio frequency, RF, device 316 and 326.

As indicated in FIG. 5 both basebands 314 and 324 are coupled as well as is the LTE-U baseband 324 and the W RF module 316. This interface can also be referred to as a bus system connecting the LTE-U portion of the user equipment with the WLAN portion of the user equipment. Known hardware does not provide the two connections between the LTE-U part and the WLAN part. What can be seen in FIG. 5 is that the baseband 324 of the LTE-U part can address the RF device 316 of the WLAN part of the user equipment. Hence, not only a co-existence of LTE-U and WLAN is derived but also a newly developed integration of both.

To perform carrier selection, a priority of each of the available channels is determined. A channel being assigned priority 1 is the most appropriate for the LTE-U operation, while priority 2 is the second best and so on. The WLAN baseband 314 tests the single channels in a given spectrum band. For the case that on one channel energy is measured the WLAN baseband 314 examines this channel in more detail. If a different WLAN is operating, the beacon will be read out and determined if an infrastructure mode or an ad-hoc mode is present. In case of an infrastructure mode an access point may be present in one or several connected WLAN end devices. In case an ad-hoc mode is detected one or several WLAN capable end devices and no central elements such as a router is present. Within these two channels it is of advantage to assign the channel in the ad-hoc mode a higher priority than to the channel in the infrastructure mode as an ad-hoc network is only of temporary presence and is mobile. An access point in contrast to this is typically operated over a longer period of time and is location static. A further reason is that a commercial service such as the provision of a public hot spot is always operated in the infrastructure mode, while ad-hoc networks are typically of private fashion. Also the range and therefore the transmission power of the devices in the ad-hoc mode is typically lower as the ones of the access points, which may communicate with more distant end devices if required.

In case the WLAN specific measurement does not deliver any results it could be because of the presence of lower energy due to a greater distant WLAN or other interfering transmission techniques, such as Bluetooth or DECT, may be present. In this case the priority of this channel should be in between the ad-hoc and the infrastructure mode. In case the measured energy on a non-WLAN-channel is above a certain threshold an unknown LTE-U operation may be present, which may result in a lower priority compared to a channel being operated in the ad-hoc mode.

Also the available channels may be assigned different priorities. The lower frequency bands are more appropriate concerning energy issues and are less disturbed by obstacles such as walls. The freely available channels around the channel being used by the WLAN itself are less appropriate for the LTE-U operation than a channel being more far away as within the device on neighboring channels more interference is expected. The result of the support of the WLAN unit could therefore be a list of priority of the channels. For a final selection of the channel for the LTE-U operation further criteria should be considered, apart from the list of priorities of the channels as discussed above. Such criteria could be other LTE-U communication, configurations or regulations between mobile telecommunication system providers or legal aspects. According to the present invention the priority list of the channels being provided by the WLAN unit together with further criteria is considered regarding the final carrier selection. A decision unit, such as the carrier selection module for selecting the LTE-U channel or carrier may be integrated in the WLAN module or in the LTE-U unit. It could be as well an independent module in the mobile device or in the network.

The shown interface provides a logical and direct connection of the WLAN module with the LTE module. The person skilled in the art recognizes that both protocol stacks are mirrored and the two connecting lines are integrated. For the implementation of such an interface the person skilled in the art appreciates that several embodiments are possible.

A physical interface at the respective baseband chip on both sides can be implemented, for instance a pin for the serial data transmission. This embodiment requires further amendments regarding the WLAN baseband as well as the LTE baseband. Especially an unamended WLAN baseband would be of advantage due to economic reasons, which results in hardware efficiency. A required synchronization of both radio technologies for a shared resource usage and their controlling regarding time can be implemented by a shared time signal, which can be delivered from the end device over a not further shown interface to the module. The provision of a module, for instance the WLAN module, with the time signal, for instance slot timing, of the respectively other module, for instance the LTE module, is of advantage.

The interface may also be provided by a logical connection of the protocol stacks, which communicate over higher layers and therefore use the existing interfaces or communication paths. The required synchronization on the respective interface can be accomplished by shared time stamps on the basis of the aforementioned time signals.

The interface can also be provided by a coordination of the LTE module and the WLAN module by higher layers, which control the usage of the frequencies and carriers as well as the synchronization regarding the time. The WLAN module and the LTE module can be operated passively in this embodiment and are controlled by the higher layers regarding the aforementioned parameters.

It is also of advantage to launch a carrier selection in the WLAN baseband being invoked by the LTE baseband before a transmission using LTE-U, for instance after a longer pause. In this case the carrier selection is part of the reoccurring media access procedure for the LTE-U frequency band.

FIG. 6 shows the system for selecting an LTE carrier in a wireless telecommunications system and shows especially a respective base station BS and a respective user equipment UE. As can be seen in FIG. 6 the present invention may also be implemented by a separation of the LTE module and the WLAN module, also referred to as Wi-Fi module. Further devices may also be provided, which hold the priority module and the carrier selection module. These further modules may as well be integrated for instance in one of the UE or the BS.

An advantage of linking the LTE-U and WLAN modules in the manner shown is that the transmissions using LTE and WLAN can be better coordinated. Transmission specifications of WLAN, can lead to transmission and reception pauses, which can be used by LTE-U for the transmission of data or for accomplishing short measurements. Likewise the system can arrange its operations in a fashion that for a predictable period of time sending/or reception of data from the respectively other system is possible or restricted. Such operation configurations can be coordinated to operate both systems in parallel. The coordination comprises the reporting of WLAN activity times by the WLAN module to the LTE module and ensuring that the LTE-U module does not use LTE in case these activities would interfere with the activities of the WLAN module. It may be the case that the LTE module transmits data alternatively over the LTE infrastructure or delays its transmission or reception. The other way round it may be possible that the LTE module reports LTE-U activities to the WLAN module, which does not accomplish any activities during the reported periods of time.

The WLAN compatible mobile devices typically comprise a WLAN baseband with one or several frequency specific high frequency modules, also referred to as WLAN-RF, as well as the mobile transmission module being coupled to one or more frequency specific high frequency modules RF. For the usage of LTE in the unlicensed spectrum, for instance the 5 GHz band, the following two embodiments are possible. Firstly, LTE-U uses its own RF module, for instance with a separate LTE-U antenna and the WLAN baseband uses another WLAN-RF. Secondly, LTE-U uses the same RF module, for instance with a shared antenna, with the WLAN baseband WLAN-RF, which can then be connected with one of both basebands. In this case a change in the connection between WLAN-RF and one of the basebands may be required, which allows for a carrier selection by means of the WLAN baseband and independently of the selection result and allows for a data transmission through the mobile telecommunications baseband. It may also be the case that the WLAN RF is permanently connected with the WLAN baseband, wherein the WLAN baseband passes the packets from the mobile telecommunication baseband, also referred to as LTE-U baseband, to the WLAN-RF.

In both cases it is of advantage to synchronize the timing for sending and receiving between the LTE-U and WLAN. In the first case this should be accomplished for minimization of interference and provision of a maximum of transmission power and in the second case to make a resource allocation, for instance scheduling, of one RF module towards several basebands more effective than a static a-priori defined access on the shared resource. While in LTE-U a static timing has to be followed, provided by the base station, the timing in WLAN is developed by the interactive data communication. A device on one channel requests a time slot for sending to another device. In case this request RTS is received by a device in the network, which is not addressed, a pause in the length of RTS time interval results, in which the not-addressed device is not allowed to send on this very specific channel and does not need to listen on said channel. It is of advantage to provide those RF resources of the LTE-U unit for this very specific RTS time slot, which are locked for this channel for further locking the LTE-U access. The other way round, in case the WLAN unit of the terminal may send itself a request to send RTS to another device and thereupon has received a clear-to-send CTS. The RF resource should be assigned for this time slot, namely the CTS time slot to the WLAN.

Further solutions for a specific implementation of the high frequency module RF of a mobile device are also possible. For instance a simultaneous sending on neighboring channels is possible, in case the timing of both signals is synchronous. Alternatively a simultaneous sending, for instance with two separate RF units, for LTE-U and WLAN on arbitrary carriers is possible as far as certain requirements are fulfilled. A simultaneous sending in one module and reception in the other one may be restricted by further requirements.

FIG. 7 shows an LTE base station LTE BS and two user equipment UE A and UE B, which operate according to an aspects of the present invention. The present FIG. 7 will be explained in detail with reference to further aspect of the invention according to FIG. 8. In the following the synchronization of time interval level is described.

As can be seen in FIG. 7 the mobile telephone B, also referred to as user equipment B UE B, sends a request-to-send RTS to the WLAN access point for using the shared telecommunication resource. This is indicated by protocol step 1. Afterwards the access point acknowledges this request and sends a clear to send message CTS. This CTS message is received by all mobile devices being registered to the access point WLAN AR This message holds for the user equipment B the permission to send for a specific interval of time considering the special time intervals SIFS and CIFS. All further mobile stations, such as mobile station A, receive the CTS for the user equipment B. This means for user equipment A that for the same interval, including time intervals SIFS and CIFS, that neither sending nor receiving is to be accomplished as the shared transmission resource is allocated for transmittance of user equipment B.

In a third step the mobile telephone A communicates to the LTE network over a cellular connection to the base station that for the predefined time interval the transmission resource is available for LTE-U. Such a transmission resource may be the HF-module in the 5 GHz band. This can also be communicated by a so called “available” message. The internal communication between both entities within the mobile telephone is shown in FIG. 5. The WLAN module sends a “free” message to the LTE-U unit including the information for which period of time the WLAN unit is free. This means the WLAN unit does not send and furthermore is not ready for reception.

In a fourth step the user equipment B may communicate to the LTE network, also over a cellular connection to the base station, that the transmission resource is not available for the same defined period of time by transmission of a “busy” message. The internal signaling is also depicted in FIG. 5. The WLAN module transmits a “busy” message to the LTE-U unit indicating for which period of time the WLAN resource is busy as itself sends data. This is also shown in FIG. 8 indicating the period of time when the medium is allocated or occupied OCC.

A further embodiment is depicted in FIG. 9, in which the LTE-U unit transmits its “busy” status to the WLAN unit. The mobile telephone receives the timing for the LTE-U operation through the network. LTE is based on a static timing with time slots being equal in length. Therefore it is known, how long the resource is allocated in the mobile telephone for sending or receiving of LTE-U data.

The LTE-U unit transmits a “busy” message to the WLAN unit indicating the period of time the LTE-U resource is allocated.

After this period of time the LTE-U unit is not allocated and the WLAN unit sends a request-to-send RTS to the WLAN access point. After reception of the CTS message from the WLAN access point it is known for how long the WLAN resource will be allocated. The intervals SIFS and CIFS need to be considered due to the WLAN synchronization without allocating the WLAN resource. The WLAN unit may inform the LTE-U unit about the allocation.

Special effort is posed on the resource management regarding the 5 GHz operation in a mobile telephone. Transmission resource therefore addresses the hardware resources in the mobile telephone. Furthermore the avoidance of interferences at a shared usage of the antenna or the usage of two separate antennas being closely located to each other within one mobile telephone is addressed.

FIG. 10 illustrates the results of a carrier selection and a resulting priority value, ich is computed as a function of the detected carrier performance parameters. As shown in FIG. 10, those carriers for which no energy is detected are assigned the highest priority numbers, in this case, 1 to 3. Next highest priority number 4 is assigned to carriers where transmission energy was detected but of unknown source, followed by carriers where following a read of the SSID, an ad-hoc mode or an infrastructure mode was detected.

The present invention is of advantage as the transmission resources are synchronized as well as the user experience is enhanced not only due to increased bandwidth and therefore the value of used devices. A WLAN carrier detection uses available resources of legacy systems more efficiently because of the parallel operation. It is of special advantage that legacy devices can be adapted towards an implementation of the present invention.

In case the LTE-U unit in the mobile terminal functions autonomously without cooperation with the WLAN module the present invention can be implemented according to the following two enhancements. Firstly, the new carrier selection functionality in the autonomous LTE-U unit relies on WLAN not only with a pure energy measurement, but considers the WLAN signaling on the respective channels. Secondly, the LTE-U unit requests the state, allocated resources and signals over higher layers from the WLAN unit and considers this information for resource management.

It can be the case that the LTE baseband configures the WLAN baseband for a carrier selection prior to a potential usage of LTE-U. This may be accomplished if a usage of LTE-U is in the current situation detected as being possible or not. This information is indicated from the mobile device to the telecommunications network for supporting a configuration of the LTE-U usage by the network. Especially at a coordinated request of the base station towards several user equipment the present invention is able to deliver an extensive report of the present situation of the WLAN usage scenario in a telecommunications cell. Furthermore, a location stamp can be provided along with the measurement results. In an alternative embodiment this information may be used for a decision in the user equipment towards how the usage or the non-usage of LTE-U is accomplished.

The person skilled in the art appreciates that the invention as set forth above is merely described by way of illustration and that further aspects are comprised, such as:

A system for LTE carrier selection in a wireless telecommunication system, the system comprising: a WLAN module being arranged to measure at least one carrier performance parameter per at least one carrier; a carrier priority module being arranged to assign a priority value to each of the at least one carrier as a function of the measured at least one carrier performance parameter; and a LTE module being arranged to transmit on a carrier being selected by a carrier selection module as a function of the assigned priority value.

The system according to any of the preceding aspects, wherein a single unit is provided comprising at least one of the WLAN module, the carrier priority module, the LTE module and the carrier selection module.

The system according to any of the preceding aspects, wherein the at least one carrier performance parameter indicates an interference level on a carrier.

The system according to any of the preceding aspects, wherein the carrier priority module is arranged to assign the priority value as a function of a measured location value indicating a geographic position of a user equipment and/or WLAN signaling, such as a beacon.

The system according to any of the preceding aspects, wherein the carrier with the least interference level is selected for transmission.

The system according to any of the preceding aspects, wherein the measurement of the at least one carrier performance parameter is invoked by the LTE module.

The system according to any of the preceding aspects, wherein the LTE module operates according to the LTE-U standard.

The system according to any of the preceding aspects, wherein at least one module is arranged to operate at least in part in an unlicensed spectrum, such as 5 GHz.

The system according to any of the preceding aspects, wherein at least one module is comprised in a user equipment and/or base station.

The system according to any of the preceding aspects, wherein the base station is arranged to invoke the measurement performed by the WLAN module.

The system according to any of the preceding aspects, wherein the WLAN module functionality is provided by at least one hardware adaption of a commonly known WLAN module and/or by deployment of instructions through a configuration interface on a commonly known WLAN module.

The system according to any of the preceding aspects, wherein the LTE module provides an interface for communication with the WLAN module for interchanging at least one of the carrier performance parameter, the priority value, the interference level, the location stamp, the WLAN signaling and signals received by an antenna being connectively coupled to the WLAN module.

A method for selecting a LTE carrier in a wireless telecommunication system, the method comprising: measuring at least one carrier performance parameter per at least one carrier by means of a WLAN module; assigning a priority value to each of the at least one carrier as a function of the measured at least one carrier performance parameter by means of a carrier priority module; and transmitting by means of a LTE module on a carrier being selected by a carrier selection module as a function of the assigned priority value.

A computer readable medium comprising instructions stored thereon to cause one or more processors to accomplish the method according to any of the preceding aspects.

A user equipment in a wireless telecommunication system, the user equipment comprising: a WLAN module being arranged to measure at least one carrier performance parameter per at least one carrier, the WLAN module being connectively coupled to a carrier priority module being arranged to assign a priority value to each of the at least one carrier as a function of the measured at least one carrier performance parameter, wherein a LTE module transmits on a carrier being selected by a carrier selection module as a function of the assigned priority value.

A method for operating a user equipment in a wireless telecommunication system, the method comprising: measuring at least one carrier performance parameter per at least one carrier by means of a WLAN module; assigning a priority value to each of the at least one carrier as a function of the measured at least one carrier performance parameter by means of a carrier priority module, transmitting by means of a LTE module on a carrier being selected by a carrier selection module as a function of the assigned priority value.

A computer readable medium comprising instructions stored thereon to cause one or more processors to accomplish the method according to any of the preceding aspects.

A base station in a wireless telecommunication system, the base station comprising: a LTE module being connectively coupled with a WLAN module being arranged to measure at least one carrier performance parameter per at least one carrier, the WLAN module being connectively coupled to a carrier priority module being arranged to assign a priority value to each of the at least one carrier as a function of the measured at least one carrier performance parameter, wherein the LTE module transmits on a carrier being selected by a carrier selection module as a function of the assigned priority value.

A method for operating a base station in a wireless telecommunication system, the base station comprising: measuring at least one carrier performance parameter per at least one carrier by means of a WLAN module; assigning a priority value to each of the at least one carrier as a function of the measured at least one carrier performance parameter by means of a carrier priority module, transmitting by means of a LTE module on a carrier being selected by a carrier selection module as a function of the assigned priority value.

A computer readable medium comprising instructions stored thereon to cause one or more processors to accomplish the method according to any of the preceding aspects.

1. A method of selecting a carrier for radio communication according to a first communication protocol, the method comprising:
determining for each of a plurality of possible carriers a measurement of received transmission signal energy;
for each carrier having a measured received transmission signal energy greater than a predetermined threshold, attempting to determine a further transmission parameter according to a second communication protocol;
assigning to each of the plurality of possible carriers, a priority value using the measurement of received transmission signal energy and where determined the determination of the further transmission parameter; and
selecting a carrier for communication according to the first communication protocol dependent on the assigned priority values.

2. The method according to claim 1, wherein the further transmission parameter is an identification parameter.

3. The method of claim 1, wherein the first communication protocol is in accordance with the Long Term Evolution, LTE, standards.

4. The method according to claim 1, wherein the second communication protocol is in accordance with the IEEE 802.11 family of standards.

5. The method of claim 4, wherein a carrier in which an ad-hoc mode transmission is detected is given a higher priority than a carrier in which an infrastructure mode transmission is detected.

6. The method of claim 5, wherein a carrier in which energy from an unknown source is detected is given a higher priority than a carrier in which either an ad-hoc mode or an infrastructure mode transmission is detected.

7. The method according to claim 1, wherein transmissions according to the first communication protocol are coordinated with transmissions according to the second communication protocol.

8. The method according to claim 1, wherein transmissions according to the first communication protocol and the second communication protocol are accomplished over the same antenna device.

9. The method according to claim 1, wherein operation of the first
communication protocol and operation of the second communication protocol is coordinated over a shared interface.

10. The method according to claim 1, wherein a location detection is performed, which is considered when assigning to each of the plurality of possible carriers a priority value.

11. The method according to claim 1, wherein a hardware configuration is considered when assigning to each of the plurality of possible carriers a priority value.

12. The method according to claim 1, wherein measurements on respectively neighboring carriers are considered when assigning to each of the plurality of possible carriers a priority value.

13. A method of selecting a carrier for transmissions in an unlicensed frequency band in accordance with the Long Term Evolution, LTE, standards, the method comprising:
using a baseband module adapted to operate according to the IEEE 802.11 family of standards to measure a received transmission signal energy for each possible carrier,
using the baseband module to determine a further parameter at least for each carrier having a received transmission signal energy greater than a predetermined threshold;
allocating a priority value to each carrier as a result of the received transmission signal energy measurements and the further parameter determinations where determined; and
selecting a carrier dependent on the priority values of the possible carriers.

14. A radio communication terminal having a transmission capability for transmitting in accordance with a first radio communication protocol and a transmission capability for transmitting in accordance with a second radio communication protocol, the terminal including a first processor module and a second processor module, the first processor module being configured to manage radio functions for transmission according to the first radio communication protocol and the second processor module being configured to manage radio functions according to the second communication protocol,
characterized in that an interface is provided between the first processor module and the second processor module and wherein the first processor module is adapted to communicate with the second processor module in a manner such that a search for a suitable carrier for transmissions according to the first communication protocol is performed by the second processor module.

15. A base station having a transmission capability for transmitting in accordance with a first radio communication protocol and a transmission capability for transmitting in accordance with a second radio communication protocol, the base station including a first processor module and a second processor module, the first processor module being configured to manage radio functions for transmission according to the first radio
communication protocol and the second processor module being configured to manage radio functions according to the second communication protocol,
characterized in that an interface is provided between the first processor module and the second processor module and wherein the first processor module is adapted to communicate with the second processor module in a manner such that a search for a suitable carrier for transmissions according to the first communication protocol is performed by the second processor module.
